(19) United States
(12) Patent Application Publication
(10) Pub. No.: US 2026/0148302 A1
(43) Pub. Date: May 28, 2026

(54) ASSET MONETIZATION WAREHOUSE

(71) Applicant: I3 TECHNOLOGY MANAGEMENT LTD., Charlestown (KN)

(72) Inventors: Bernhard Fritsch, Malibu, CA (US); Debra Domeyer, Malibu, CA (US)

(21) Appl. No.: 18/739,290

(22) Filed: Jun. 10, 2024

Related U.S. Application Data
(60) Provisional application No. 63/472,065, filed on Jun. 9, 2023.

(51) Int. Cl. G06Q 40/04

(52) U.S. Cl. CPC G06Q 40/049

(57) ABSTRACT

Embodiments directed to computer processes for building a global marketplace and recognized standards for automated, high investment secure assets are provided. The secure assets may include, but are not limited to, carbon credits. A digital monetization warehouse and economies platform eliminates the middleman and redefines the way global assets are defined, insured, purchased, and sold.

### BACKGROUND

Greenhouse gases (GHGs), such as carbon dioxide (CO2), methane (CH₄), and nitrous oxide (N₂O), trap heat in the Earth's atmosphere, contributing to the greenhouse effect and global warming. These emissions primarily come from human activities, including burning fossil fuels for energy, industrial processes, deforestation, and agriculture.

Rising temperatures are causing extreme weather, tropical storms, wildfires, and severe droughts. Our oceans and waters are no longer clean and blue due to carbon emissions which have dramatically increased CO2. Even with global efforts to reduce CO2 emissions, it recently reached an all-time high of over 58 Giga Tons.

Obtaining net zero to negate the amount of greenhouse gases produced by human activity by reducing emissions and implementing methods of absorbing carbon dioxide from the atmosphere is desired. Net zero refers to a state in which the emissions of greenhouse gases (GHGs) released into the atmosphere are balanced by the removal or offsetting of an equivalent amount of those emissions.

Achieving net zero emissions requires a comprehensive approach involving governments, businesses, communities, and individuals. It demands transitioning to a low-carbon economy, investing in renewable energy infrastructure, adopting sustainable practices across sectors, and promoting technological advancements. The ultimate goal is to balance the remaining emissions with sufficient offsets to ensure that the overall impact on the climate is neutral.

Net zero may be achieved by (1) Emission Reductions: Implementing measures to minimize and reduce emissions is the first and most crucial step. This can include transitioning to renewable energy sources, improving energy efficiency, adopting sustainable practices in industries, promoting low-carbon transportation, and implementing forest conservation.

### SUMMARY

The following presents a simplified summary of one or more implementations in order to provide a basic understanding of some implementations. This summary is not an extensive overview of all contemplated implementations and is intended to neither identify key or critical elements of all implementations nor delineate the scope of any or all implementations. Its sole purpose is to present some concepts of one or more implementations in a simplified form as a prelude to the more detailed description that is presented later.

According to one example, a computer system configured to communicate with a distributed blockchain computer system that includes a plurality of computing devices, each computing device of the plurality of computing devices configured to store a copy, or a portion thereof, of a blockchain of a digital blockchain exchange operated by the distributed blockchain computer system is provided. The computer system comprises at least one transceiver configured to communicate with one or more of the plurality of computing devices of the distributed blockchain computer system; at least one processor; and at least one computer readable memory configured to communicate with the processor, the computer readable memory having a non-transitory computer-readable storage medium configured to store instructions, that when executed by the at least one processor. The computer system is configured to identify, by the computer system, one or more carbon assets of interest; select, by the computer system, at least one carbon asset from the one or more carbon assets for onboarding onto a storage device; validate, by the computer system, the at least one carbon asset; tokenization, by the computer system, of the at least one carbon asset into one or more carbon credit digital tokens; and monitoring, by the computer system, of the at least one carbon asset using blockchain oracles to ensure the validation of the carbon credit through its lifecycle.

According to one aspect, proceeds from a sale of the one or more carbon credit digital tokens are invested into at least one carbon asset of interest.

### BRIEF DESCRIPTION OF DRAWINGS

FIG. 1 illustrates a block diagram of a global asset marketplace that can be used across both tangible and intangible assets to provide simplified access with a target on quality and industry standards.

FIGS. 2a and 2b illustrate the Asset Onboarding feature for both the Asset Owner and Asset Buyer on the Global Asset Marketplace

FIG. 3 illustrates the data stores and application components encompassing the Digital Asset Warehouse feature in the development of the Global Asset Marketplace.

FIGS. 4a and 4b illustrate the certification of assets which assesses, verifies, insures, certifies, and tokenize assets.

FIG. 5 illustrates the monetization with the positioning and placement of the carbon credits on the Global Asset Marketplace.

FIG. 6 illustrates a flowchart and data used in support of the lifecycle management of each asset.

FIGS. 7a and 7b illustrate the calculations with the development of the computer process for a reinvestment cycle conducted from proceed reinvestments and demonstrates the recycle of new assets through the Global Asset Marketplace.

FIG. 8 illustrates an end-to-end diagram of the Asset Global Marketplace from an application architecture perspective. It highlights key features including the Asset Onboarding, Blockchain Validation Engine, Asset Monetization Marketplace, and Asset Tracking & Tracing in accordance with the principles of the present inventions.

FIG. 9 illustrates the Business & Process Flow using Carbon Offsets as the Asset-type.

FIG. 10 provides a broad overview of the asset card concept that is part of the onboarding process and is a key innovation of the Global Asset Marketplace.

### DETAILED DESCRIPTION

In the following description, specific details are given to provide a thorough understanding of the described implementations. However, it will be understood by one of ordinary skill in the art that the implementations may be practiced without these specific details. For example, certain aspects may be illustrated with simplified representations in order not to obscure the implementations in unnecessary detail. In other instances, well-known techniques may be shown in broad block form in order not to obscure the described implementations.

### Terms

“Comprise” and variations, such as “comprising” and “comprises,” are not intended to exclude other additives, components, integers or steps. “A”, “an,” and “the” and similar referents used herein are to be construed to cover both the singular and the plural unless their usage in context indicates otherwise. The word “exemplary” is used herein to mean “serving as an example, instance, or illustration.” Any implementation or embodiment described herein as “exemplary” is not necessarily to be construed as preferred or advantageous over other embodiments or implementations. Likewise, “embodiments” does not require that all embodiments include the discussed feature, advantage or mode of operation.

“Aspects” do not require that all aspects of the disclosure include the discussed features, advantages, or modes of operation.

“Coupled” is used herein to means the direct or indirect coupling between two objects. For example, if object A physically touches or couples to object B, and object B touches or couples to object C, then objects A and C may still be considered coupled to one another, even if they do not directly physically touch each other.

Additionality-ensures that the project plan improves the current performance standard, and that the reduction wouldn't have happened regardless of the project. Testing must ensure that the current performance standard is being exceeded by a certain measure, as defined in the applicable methodology, and that it meets a regulatory additionality test.

Carbon Offset Project Type includes, but not limited to,
a) Afforestation, Reforestation and Revegetation (ARR). Projects that increase carbon sequestration by establishing, increasing, or restoring vegetative cover (forest or non-forest) through the planting, sowing or human-assisted natural regeneration of woody vegetation. Eligible ARR projects may include timber harvesting in their management plan. * The project area shall not be cleared of native ecosystems within the 10-year period prior to the project start date.
b) Improved Forest Management. Engaging in land management activities that enhance carbon stocks in forests. Methodologies involved include logging specifics, rotation changes, low-productivity to high-productivity forests.
c) Reduced Emissions from Deforestation and Degradation (REDD+ or REDD++)-REDD+ goes beyond deforestation and forest degradation and includes the role of conservation, sustainable management of forests, and enhancement of forest carbon. REDD++ refers to a broader suite of land-use activities, including things like agriculture, and land management.

Carbon Offset Methodology. Carbon Offset Methodologies are the tier below the Carbon Offset Project Type that details how the carbon offsets will be acquired. Examples for the Improved Forest Management Project Type, includes:
a) Reduced Impact Logging
   Projects that reduce net GHG emissions by switching from conventional logging to reduced impact logging during timber harvesting.
b) Logged to Protected Forest
   Projects that reduce net GHG emissions by converting logged forests to protected forests.
c) Extended Rotation Age/Cutting Cycle
   Projects that reduce net GHG emissions of managed forests by extending the rotation age or cutting cycle and increasing carbon stocks.
d) Low-Productive to High-Productive Forest
   Projects that increase carbon sequestration by converting low-productivity forests to high-productivity forests. This is done by improving the stocking density of the forest and/or introducing other tree species with higher growth rates.

Detection Technology—Technology such as sensors, satellites, AI, etc., to detect emissions.

Emissions-Human emissions of carbon dioxide and other greenhouse gases—are a primary driver of climate change—and present one of the world's most pressing challenges. This link between global temperatures and greenhouse gas concentrations—especially CO₂—has been true throughout Earth's history.

### CO2e Calculator

| | | |
|---|---|---|
| Kyoto Gases | | Global Warming |
| (IPCC 2007) | Greenhouse Gas | Potential (GwP) |

| | |
|---|---|
| Carbon dioxide (CO₂) | 1 |
| Methane (CH₄) | 25 |
| Nitrous oxide (N₂O) | 298 |
| Hydrofluorocarbons (HFCs) | 124-14,800 |
| Perfluorocarbons (PFCs) | 7,390-12,200 |
| Sulfur Hexafluoride (SF₆) | 22,800 |
| Nitrogen trifluoride (NF₃) | 17,200 |

Jurisdictional & Ownership Rights—identify the type of jurisdiction (i.e., national or subnational, how many levels below national level). The jurisdictional approach seeks to align laws, interests, and coordinate actions among governments, businesses, local communities toward the shared conservation, supply chain, and green development goals. Evidence that all emission reductions are clearly owned by this project and that additional owners, projects, etc., cannot also claim the same reductions.

Leakage Validation—ensures that no decrease in emissions or in sequestration outside the project boundaries occurs because of the project action.

MCC-1 Token—The MCC-1 Token is defined as one carbon credit with a value of one ton of CO2e emission reduction, or its equivalent.

Permanence—permanence refers to the longevity of emission removal enhancements and the risk of reversal (i.e., the risk that the emission reduction benefit will not be permanent). The Permanence minimum for the MCC-1 Token is 20 years.

### OVERVIEW

The present disclosure provides for a global marketplace for automated, secure asset implementation. Investors are given the opportunity to purchase fractionalized carbon assets by means of a clean, straightforward interface. Asset owners are onboarded through a simple, self-directed process and have the ability to set their own investment terms bypassing complicated financial processes which unlock investment potential for a greater share of the market.

Furthermore, the present disclosure embodies warehouse platforms where clients can have direct engagement with any user and can easily define, monetize, trade and distribute assets for an unlimited time without the need for a middleman.

Every transaction, sale, and purchase are recorded on a blockchain platform. This creates a continually updated, highly secure, and transparent record of legal ownership. The platform includes blockchain technology innovation, artificial intelligence, data strategy, and global payment processing. It also provides tracking and tracing of the asset history and status, a financial snapshot, and related industry perspective.

Features and advantages of the claimed subject matter will be apparent from the following detailed description of embodiments consistent therewith, which description should be considered with reference to the accompanying drawings. While the present disclosure is described primarily with respect to carbon credit assets, the present disclosure may be applied and adapted to various applications and asset types. The present disclosure may be applied in carbon credit assets & associated applications, in addition to various tangible and nontangible assets including music & entertainment, intellectual property/patents/copyrights, digital and traditional art, commercial and residential leasing & real estate applications and asset types where there is a need for asset quality validation, enhanced asset security, global recognized standards, frictionless financial transactions, simplified digital management, and asset-to-market acquisition speed.

### Global Asset Marketplace

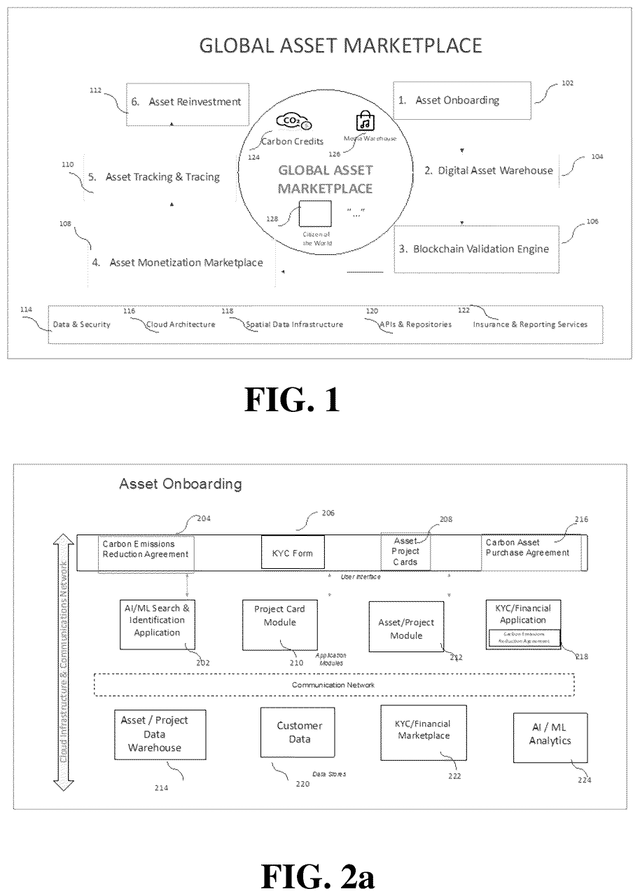

FIG. 1 illustrates the development of a Global Asset Marketplace that can be used across both tangible and intangible assets to provide simplified access with a target on quality and industry standards. Each asset is onboarded via a simplified Project Card process, guiding both Asset Owners and Asset Buyers toward their targeted asset detail 102. As data specific to each asset is entered onto the Digital Asset Warehouse Platform, it is stored for historical review and future metrics 104. The third major function is validation and certification of the assets including assessing, verifying, insuring, certifying, and tokenizing the assets 106. Algorithms are automated on the MGN Platform to validate this process based on machine learning with previous asset experience and asset expertise. A partnership with the Asset Owner assists us in recording all detail necessary for certification including asset unit detail, asset project and quality measures, compliance with the Asset Token, test criteria & certification, monitoring for lifecycle review, and other channel-specific and/or social advantages. As part of confirmed certification, is the tokenization of the asset. Positioning and providing the carbon credits on the Asset Transaction Marketplace provides availability to Buyers and entities wanting to use carbon credits to meet their company environmental goals and carbon offset 108. A carbon credit purchase agreement will complete the transaction of carbon credits/MCC1s. The MGN Asset Monetization Marketplace assists all parties with a friction-reduced financial process. The platform has ‘broker-dealer’ expertise built into the platform, mitigating the need for 3rd party manual intervention. An important aspect of initial and continued asset quality is through lifecycle monitoring and tracking & tracing of each asset 110. Depending on the asset-type, this can include satellite monitoring, sensors, hand-held measurement units, or other innovations integrated into the platform. The use of Artificial Intelligence (AI) monitoring and machine-learning technology plays an important role on the MGN Platform as a key component of the ongoing monitoring and tracking and tracing of the asset and through the use of blockchain oracles to ensure the validation of both the asset through its lifecycle and of any asset owner payment and client payout. Reinvestment from proceeds is an integral part of the platform 112. Monogram reinvests a percentage of its proceeds back into the asset market. A proprietary algorithm and AI marketing platform leads to rapid expansion and adoption of the marketplace. This solution scans for selected criteria and assets of interest based on the industry and known MCC asset requirements.

The Global Asset Marketplace has extensive data & security built in throughout 114. Assets and related transactions are built on an immutable ledger on a blockchain environment. A significant cybersecurity plan is developed in the management of the environment encompassing an access control policy; secured, encrypted, and tested backups; a web content policy; an endpoint detection and response policy; network protections; cybersecurity and phishing training; and hardening techniques to name a few. The environment is built on a hybrid cloud solution including data security across multiple approaches as listed above, cloud-based DevSecOps expertise integrating security practices into the development workflow, and an eye toward sustainability 116. The use of processing tools, metadata, and remote sensing are built into an affective spatial data infrastructure 118. APIs and repositories are built throughout the environment to provide access to the various data stores 120. Each asset is secured by insurance offered through a tier 1 insurance partner 122. And, finally, there is an application services layer that offers e-reporting for those assets that require frequent reporting to governments, partners, and clients. Multiple high-end assets will be integrated into this invention and have already been spec'd out. Carbon credits, the issuance of true carbon credits with 1 tCO2 sequester per carbon credit, is used as an example throughout this document 124. As a Media Warehouse Asset, each song and movie will be embodied in one asset which includes its ownership, royalty splits, retail pricing and retail media streaming capability 126. As a Citizen of the World asset, each person on planet earth and the universe can get issued a personal asset which embodies undeniable identification to each person 128. Those assets are issued from the asset warehouse platform and can trade on any exchange.

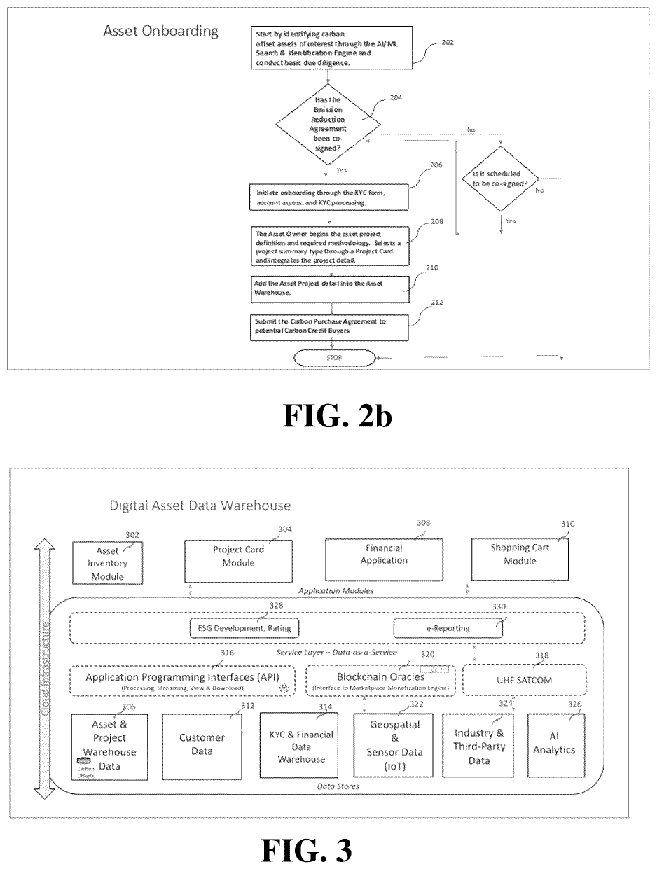

FIGS. 2a and 2b illustrate the Asset Onboarding feature for both the Asset Owner and Asset Buyer on the Global Asset Marketplace. Automation in the Smart Contract allows for the certification of carbon offsets into carbon credits. Machine learning and AI are part of the asset investment and supply chain strategy with an engine that looks across the world market to find attractive asset candidates based on selected criteria 202. The neural network system identifies assets and companies based on input metrics. These metrics drive the system to find activity from asset sources that are contextually relevant to the specified parameters. It then retrieves data from identified data sources and launches a custom intelligent bot to crawl conversations. Targeted sources of data include asset-specific industry sources, proprietary social media data via public APIs, and partner-recommended sources automatically integrated into the data layer of the platform. The desired subject matter is mapped in a hierarchical structure where a scoring algorithm is applied for relevance. Once interested sources are identified, communication bots can be integrated to further source the data. A card-based user interface provides a starting point for a carbon offset owner to select a Project Category and Project Type to initiate a project template 204.
A facial recognition interface will assist application users to easily get access to the program features.
A Know-Your-Customer (KYC) form is integrated into the application for users to easily identify themselves and gain access to the program features 206.
Assisted access to an account is controlled by a wallet with the native token required to pay for gas on the blockchain network.

The objective of the onboarding process is simplification of onboarding for both the Asset Owner and Buyer via a unique project card UI with a significant amount of asset detail and potential owner identification automated. Asset onboarding starts with the identification of assets of interest. Once an asset and Asset is identified, an agreement (Carbon Emissions Reduction Agreement) between the Asset Owner and Monogram is completed outlining the Business Purpose & Objective, Agreement Term, Party Contributions, Roadmap, Financial Distributions, and General Representations around the asset rights. This agreement is a long-term agreement, depending on the asset, covering from 5 years to 20+ years 208. Assets are presented on the Asset Global Marketplace via Project Asset Cards. The Asset Owner will be provided with a MGN Platform account and begin entering data via a Project Asset Card 210. As data is entered and after an Asset Owner has completed an agreement, data will be processed and entered into the Project Data store 212 and Asset Inventory 214. Potential Asset Buyers also will receive an MGN Platform account and will be able to view and select available assets through the Project Asset Cards. Interested Carbon Credit Buyer entities will complete the Carbon Purchase Agreement outlining the transaction terms, rights & responsibilities of each party, quantity of carbon credits, cost per carbon credit, and general representations 216. KYC processing will be completed and monitored for all partners and potential clients for initial identification and security review 218. Partner & Customer Data will be entered into the Customer Data Store 220 and KYC data will be stored in the KYC/Financial Data Warehouse 222. The AI/ML results, with levels of success, will be updated in the AI/ML Analytics Warehouse to ensure future adherence to the changes 224.

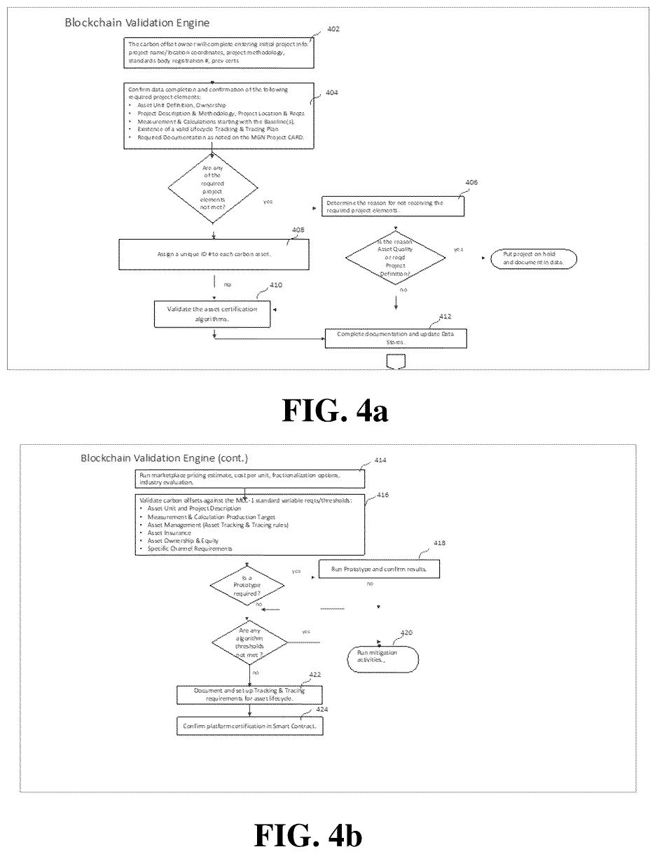

FIG. 3 illustrates the data stores and application components encompassing the Digital Asset Warehouse feature in the development of the Global Asset Marketplace.

Onboarding the asset requires the addition of all available data in the Digital Data Warehouse. Documentation of the asset is important to ensure that the asset quality, ownership, history, third-party certifications, and tests result in a quality asset. A substantial level of data is required to provide MCC certification and an ISAE 3000 Audit in support of certification. The following are the average data processing requirements, validating the correct format and within the thresholds of what is anticipated by the defined 302.
Asset Unit & Definition
   k. Description—(“One MCC-1 Carbon Credit=One tCO2 Sequestered)
   l. History by Unit/Product Type
   m. Production Status—Scale quantity
   n. Ownership Detail—Full and partial ownership
   o. Carbon Offset ID's
      onogram will ensure that all carbon offsets have unique identifiers, i.e., carbon offset identification #'s. If there are existing carbon credits, provide documentation on the unique carbon offset identification #'s, the measurement defined by each ID #, the methodology used to create the #'s, and all associated data unique to each offset.
         Unique ID #'s
         Measurements—Describe the measurement of each unique ID #: i.e., metric tons of CO2.
         ID Methodology—Describe the methodology used to create the unique ID #'s (i.e., SN's): (i.e., dates, tests, results, and/or events)
Carbon Offset Project Methodology—processing requirements, validating the correct format and qualification targets for Certification allowing for the emission reductions targeted on the Asset Project Card.
   a. Project Title
   b. Project Purpose
   c. Project Definition
   d. Project Location
   e. Crediting Period
   f. Activity Targets
   g. Project Commercial Implementation
   h. Mapping of Units in Implementation
   i. Project Participants
   j. Client Information
      Project Client Owner
      Client Location(s) & Registered Incorporation Certificate
      Payment Detail—Amount, Bank Acct #, etc.
      Client Participation
   k. Social and Channel-Specific Categories. These are areas frequently requested by national or local governments, prove benefits socially (i.e., local hiring), and/or requirements specific to a channel of assets (i.e., forest additionality). All social and/or channel specific categories are processed and entered into the Asset & Project Data Warehouse.

Metadata tracks all activities and asset status including all technical and processed financial transactions. All asset, identification, certification, and transaction data are stored as part of the Monogram Asset Token Standard. Additional data, including detailed monitoring and audit data will be identified via a link in the Smart Contract and stored off-chain.

Data is stored across multiple data segments including:
Asset & Project Data 306
Customer Data is received as part of the KYC/Financial application module which is part of the formal identification and confirmation of a customer 308 and updated as part of the Shopping Card module as a Customer acquires an asset 310. The data is then stored in the Customer Data Warehouse and the KYC/Financial Data Warehouse 314. APIs (used for partner data both directions) 316, UHF Satcom (used for satellite communications as part of lifecycle monitoring) 318, and Blockchain Oracles 320, are used to integrate external or off-chain results into the Blockchain Smart Contract both helping to generate accurate price feeds from historical data and assisting with the DeFi steps through the automation of the Buy and Sell orders. Results will then be stored in the Geospatial and Sensor Data (IoT) store 322 which is a becoming more prevalent as an important layer of lifecycle management, and the AI & Analytical Data Store 324 used across multiple services from asset management to pricing and marketing, and the Industry & Third-Party Data store 326 used for sharing performance of the industry and specific asset and demonstrating projected value & future value.

Finally, data from the Digital Asset Warehouse is key in support of several of the Services provided by the Global Asset Marketplace. Two examples are the results and ratings from ESG consulting services 328 that are offered to all carbon credit buyers and partners. Proof of rating improvements is crucial to companies looking for commercial loans. In addition, e-reporting 330 is a common request by government and public companies looking for proof of carbon emission reductions and ESG ratings.

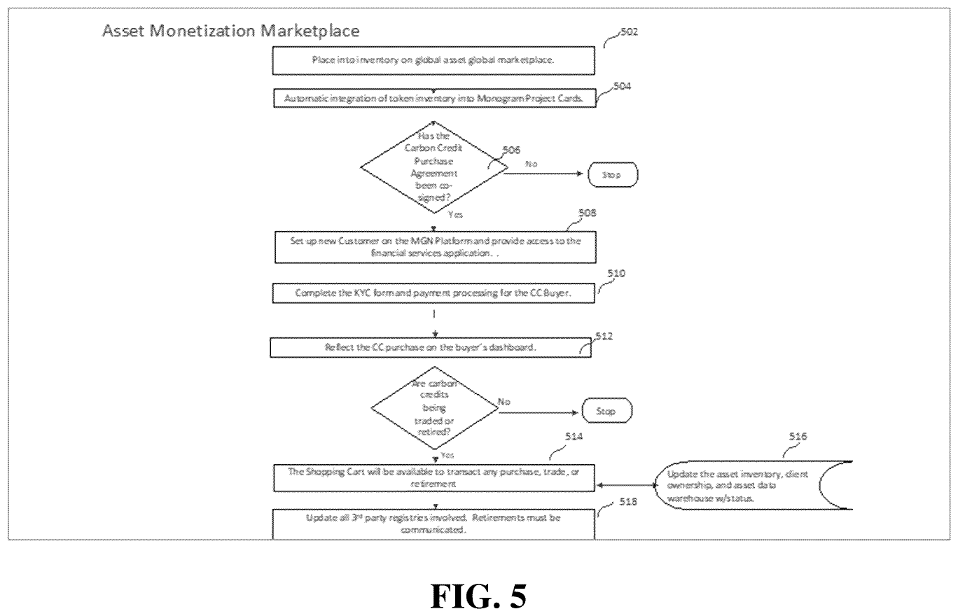

FIGS. 4a and 4b illustrate the certification of assets which assesses, verifies, insures, certifies, and tokenize assets. Leading blockchain technology provides the framework for the MCC Asset Token Standard. The Smart Contract programmatically enforces the validation and management of the assets during their lifecycle. Automated rules that determine the asset certification are built into Smart Contract algorithms. Registration and, if necessary, multi-signature verification is built into the Smart Contract. This ensures that all certification requirements to be an MCC-1 Asset Token Standard are met and that integration with any third-party carbon credit registries are also documented. Before any global asset gets minted into an MCC-1 Asset Token Standard, it must meet a set of criteria based on methodologies outlined as part of the standard. The validation process follows a specific, proprietary protocol. The assets follow the same protocol blueprint but will be asset specific based on the Asset Category and Project Type 402. As an example, the Carbon Offset project falls into the MCC Standard project and asset type including but not limited:
1. Forest, Mangrove and Agri, includes biodiversity
2. Fossil fuel modifier
3. Magnetic Valves for gas and oil pipes and refineries
4. Water Sanitation
5. Renewable energy: Solar and wind
   This validation process is specific to the MCC Asset Token Standard. At the most summarized level, a grouping of MCC Asset Token Standards must be associated with a project category and project type and validated and certified as a token standard before placed on the Global Asset Marketplace. This process must document the following elements of an asset project 404:
Asset unit definition—The asset definition includes a) a detailed unit definition, b) a basic unit definition (i.e., one token=one [asset], c) A threshold amount of reduction will be required, by project, to be certified.
Project Description & Emission Reduction Methodology (as defined in Section 3).
Project Location—with latitude and longitude
Annual Carbon Credit Production Target—This target includes the validated capability of delivering the quantity and, as appropriate, type of asset. As an example, the delivery of carbon reductions of over ‘x’ emissions or ‘x’ percentage reduction resulting in the production of ‘x’ no. of carbon credits/year for the program.
Measurable Calculations—This category should identify the testing & research facilities used and provide the methodologies and test descriptions starting with the baseline, the implementation of quality standards, product testing & research detail, regulatory & legal requirements, and documentation of the resulting savings.
   Baseline Measurement—Identify baseline data and documentation as relevant and required to evaluate the emission reduction assertions. Identify baseline data associated with industry standard examples and in various scenarios resulting in carbon emission reductions.
   Emission Reduction Savings—Identify the changes implemented and measurement calculations resulting in the emission savings versus the baseline operations. ALL emission reductions and removals should be quantifiable, using recognized measurement tools against the identified emissions baseline. Describe the process where the actual accrual of savings will be quantified.
   Test Results—Product Testing and Test Results should include both controlled testing as well as real-world testing. This should include a repository of data, reports, and scientific references that share the efficacy, safety, and regulatory results. These results should be presented in a format reasonable for sharing, such as by QR codes.
      Identify any third-party labs or partners, a brief statement of each test and what they did, and the primary contact.
      Each of these methodologies should include a brief summary of the process used in achieving the results. The methodology must start with a baseline from which to measure.
      Product Tools and Tests that are required to confirm the product performance. Document the Test Overview, Test Procedures & Parameters (i.e., the test compared x samples and identified), Key Findings & Conclusion, Quantitative Improvement, and Conclusions.
   Documentation of any new QA/QC procedures and results.
Audit Validations—Confirm and document the MCC Standard, regulatory & manufacturer requirements in support of the Project & Product(s).
   To be certified as an MCC Standard, the entire Carbon Offset Asset Project Methodology must be certified by an ISAE 3000 audit. This audit is conducted by a Monogram appointed auditing firm compliant with international auditing guidelines and standards and international ESG standards.
   Audit calculations are complete and results fit in with industry claims and look satisfactory based on algorithm estimates.
Compliance with the Asset Token Standard—to ensure compliance with the Asset Token Standard, the Asset Owner must ensure production quality at expected conditions and at scale based on the product definition.
Social and Channel-Specific Additions—Desired social and/or local enhancements will enhance an asset and channel-specific asset categories and projects may include additional requirements for certification.

Throughout the validation process, there may be progress points where asset validation issues are met. There should be mitigation steps to ensure these are resolved to provide continuation of the certification process 406.

Each carbon asset must have a unique ID and demonstrate the methodology of how the ID was assigned 408. Throughout the final validation and documentation stage, all required information must be provided and stored in the Asset Data Warehouse 410. Pricing-We have the development of a pricing model based on machine learning algorithms to include modeling & automating the Asset Price 412. An asset price will be set based on variables including cost per asset; asset program lifespan; asset history; identification of purchase patterns, times and patterns; investor payout plan; asset quality; risk/reward ratio; industry price estimates; etc. In close correlation with the asset price is the cost per asset required to develop the asset. Continued price monitoring and changes will be added to the algorithmic calculations to ensure efficiency.

A final confirmation will be conducted through Smart Cycle algorithms that all certification requirements have been met. This includes Asset Unit and Project Methodology, Measurement & Calculation Production Targets are sufficient, Asset Management (Asset Tracking & Tracing rules), Asset Insurance qualifications have been met, Asset Ownership & Equity is confirmed, and Specific Channel and or Social Requirements have been considered. A prototype is a final requirement that ensure that commercial rollout of the credits is of sufficient scale. This sets final expectation of asset quantity and scale by timeline 416. The Lifecycle Tracking & Tracing Plan is a critical step to ensure quality of the all assets during their lifecycle. Monogram is especially careful to ensure that there is not only a plan in place but that the technology used is sufficient to ensure against common issues by asset type 418. If necessary, Monogram will assist by providing monitoring. Assets are ensured by reputable insurance. Insurance coverage will provide title to and control of the asset insured under the policy 420. It will be named specifically on the policy in connection with any loss of or damage to such asset with full coverage of damage or loss incurred to the asset. The asset must meet all certification requirements as documented to the Asset Owner 422. Certification is built into the Smart Contract and will confirm a successful certification. The invention creating a commodity blockchain unit that provides buying and trading functions globally across all (major) FIAT and Crypto currencies. The asset validation is integrated into the blockchain Smart Contract as part of the tokenization process and also to ensure that the commodity is secure 424. That is, the tokenization of the carbon offsets into Carbon Credit MCC-1 Tokens on the carbon credit blockchain.

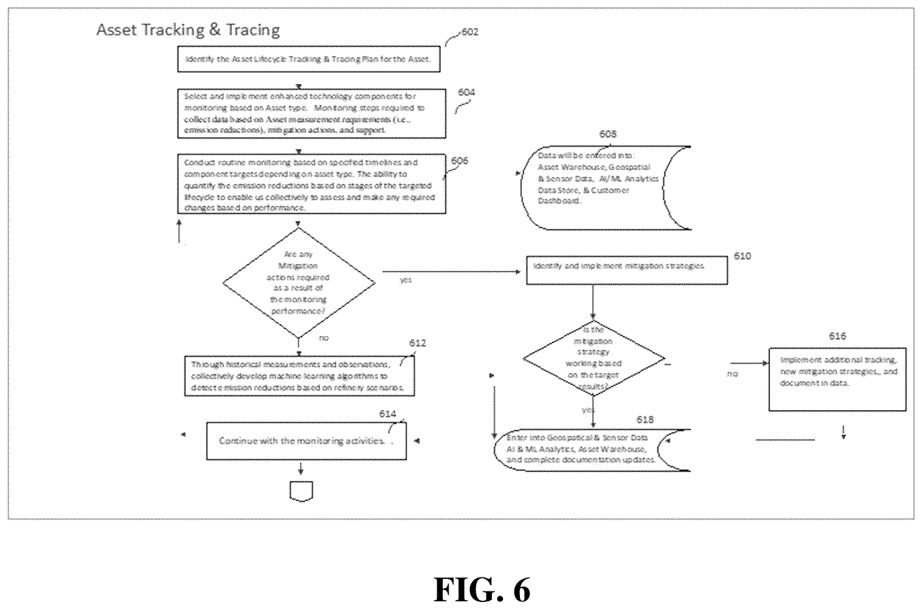

FIG. 5 illustrates the monetization with the positioning and placement of the carbon credits on the Global Asset Marketplace 502. The Project Cards are updated with the assets and are marketed and presented to entities wanting to use carbon credits to meet their company environmental goals and carbon offset 504. A carbon credit purchase agreement will complete the transaction of carbon credits/MCC-1s 506. The platform has integrated access to a financial services virtual ledger to simplify the trading function with ‘broker-dealer’ expertise built into the platform, mitigating the need for 3rd party manual intervention 508. This module automatically provides:
Online onboarding through a streamlined KYC process,
Global payment processing,
Crypto/fiat conversions,
Same day settlement, processing,
API integration with the network financial services partners, and,
A payment agent for payout confirmations.

Asset Dashboard—A dashboard is setup with all buyers, providing real-time updating of asset acquisition and status 512. Data specifically, addresses:
Financial—complete acquisition data (asset quantity, total purchase price, redemption date/amount, status of any financial transactions; disclosures); account balance, payouts, target yield; upcoming payments.
Timeline—acquisition date, activation date, payout date(s).
Asset Status—with lifecycle monitoring results.
Shopping Cart—A Shopping Cart is built into the Global Asset Marketplace for flexible purchase agreements and checking-out capabilities 514.

All transactions must be stored in the Asset Data Warehouse 516. It is crucial that assets are retired once they have been used 518. All carbon credits must be retired once the organization claims the environmental benefits or at the end of their lifecycle. MEL shall retire on behalf of the Buyer all carbon credits which have been used by the Buyer or have reached the end of their life and shall provide evidence of the retirement for those credits. Retirement of carbon credits shall occur no later than thirty (30) business days after MEL's receipt of retirement from the Buyer, documented by MEL's reference, via a retirement certificate issued to the Buyer, to the serial numbers of the carbon credits. The Smart Contract documents the retirement and communicates to any third-party registry.

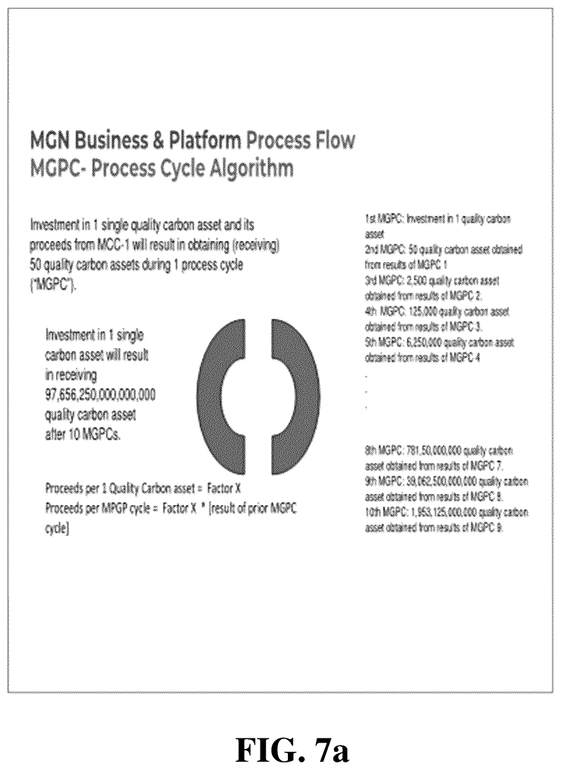

FIG. 6 illustrates a flowchart and data used in support of the lifecycle management of each asset. This has become a key component of asset management, especially in asset categories such as carbon credits, where quality has been a concern internationally. Monitoring data is managed by rules built into the Asset's Smart Contract and stored across the Asset/Project Data Warehouse to integrate with the specific carbon credit and carbon offset project. Monitoring, including specific timelines and component targets, will be provided as an integral part of the asset lifecycle, ensuring quality through the life of the asset. The Lifecycle Monitoring Plan includes alarms, diagnostic, analytic and reporting capabilities, and technology innovation integrated as part of the monitoring process to review both the base and post energy efficiency measures for the resource consumption reductions during the commissioning process, and throughout the lifecycle of the asset, to confirm the intended beneficial outcomes 602. The use of Artificial Intelligence (AI) monitoring and machine-learning technology plays an important role on the MGN Platform as a key component of the ongoing monitoring and tracking and tracing of the asset and through the use of blockchain oracles to ensure the validation of both the asset through its lifecycle and of any asset owner payment and client payout 604. It provides data on the carbon credit sourcing including the project location, date it became a carbon credit and was purchased, and all audit results undertaken to validate it as a carbon credit. Satellite monitoring is of interest with specific asset types, such as Forest carbon credit assets, as a way of monitoring the forest land. It provides for the tracking of permanence (the longevity of removal enhancements and the risk of reversal (i.e., the risk that the emission reduction benefit will not be permanent) where the requirement is a minimum of 20 years) and additionality (emission reductions or removals would not have occurred without revenue from the sale of carbon credits which is intrinsic to the environmental integrity of a carbon project.) Once the technologies are selected and the plan has been reviewed, routine measurements and monitoring will occur. Monogram has strategies in place depending on the status of the asset and the technology best selected for monitoring 606. As monitoring continues, data will be stored in the Asset/Project Data Warehouse, Geospatial & Sensor Data Store, AI/ML Analytics Data Store, and Customer Dashboard for customer access 608. Mitigation steps are required if asset target performance is not as expected and data will be stored for future analysis 610. Combined efforts between the Asset Owner and Asset Tracking & Tracing team will be built into algorithms to target emission reductions across refineries in the case of carbon credits but across many large client entities in support of not only emission reductions but ESG rating improvements 612.

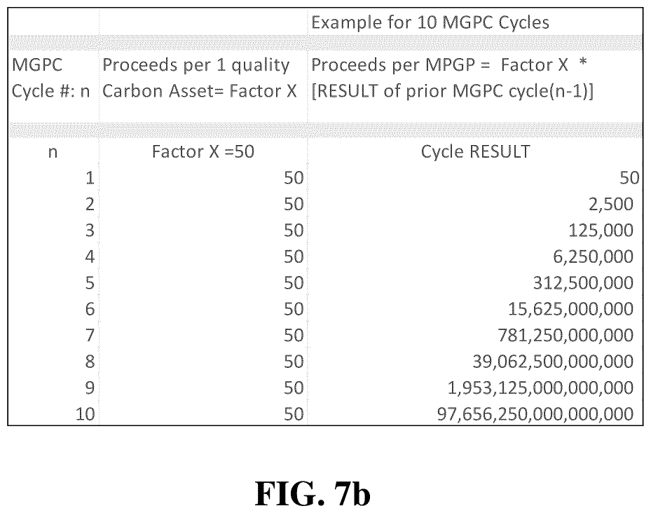

FIGS. 7a and 7b illustrate the calculations with the development of the computer process for a reinvestment cycle conducted from proceed reinvestments and demonstrates the recycle of new assets through the Global Asset Marketplace. Monogram is reinvesting profits into long-term contracts in forest management and buying carbon-reducing infrastructure providing consistent opportunities for growth and expansion.

This model is designed to create virtuous cycles where environmental responsibility is directly linked to financial profitability. By adopting the net zero programs and offsets, the global industries can leverage them to enhance their sustainability credentials, attracting global attention and investment. This, in turn, introduces new revenue streams, as these enhanced credentials can command premium market positions on a global scale. The increased efficiency and innovation driven by this initiative promise to reduce operational costs, and will further amplify profit margins. In essence this system provides dual advantage: spearheading environmental stewardship while simultaneously unlocking new economic potential. This innovative approach positions every member not just as a leading advocate in sustainability, but also as a model for how environmental initiatives will drive economic prosperity, setting a global precedent.

### Asset Monetization Platform

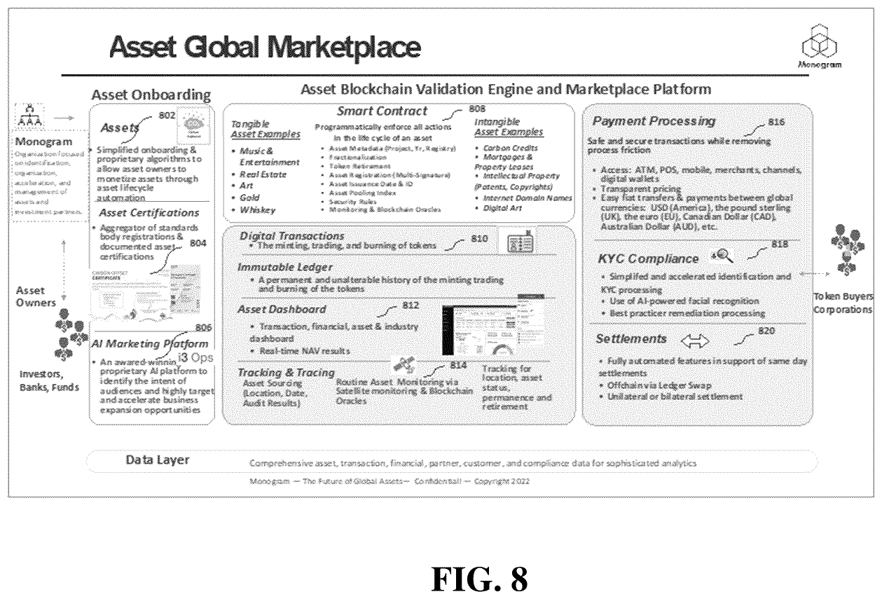

FIG. 8 highlights key application features of the Global Asset Marketplace including Asset Onboarding covering proprietary algorithms to validate and manage assets 802, the aggregation of any existing third-party certifications with the Monogram certification 804, and a proprietary AI engine for the identification of additional opportunities 806. The validation engine shows the Smart Contract rules programmatically managing the asset lifecycles 808. The Smart Contract has standard rules across all assets but also specialized rules specific to a specific asset or type of asset. It also shows on the diagram the breadth of both tangible and non-tangible assets that can be included. The blockchain is shown as part of the Validation engine with the immutable ledger and minting function 810. Some data items will be kept on-chain, meaning on the blockchain, and some will be tied to a particular asset but will be considered off-chain as the variable may be changeable. An asset dashboard is provided for the client view of their asset purchase including the financial transaction, timeline, and asset status from lifecycle monitoring results 812. And the steps and performance of the quality lifecycle monitoring component is listed with several options 814. The financial modules shows secure payment processing targeting reduced friction across multiple currencies 816; integration of the KYC identification compliance across all customers and partners 818, and the settlement feature across multiple options 820. Innovation within the settlement feature is an area of strong innovation and there are many opportunities for a frictionless payment cycle.

As shown in FIG. 8, there are 4 key components of the Asset Monetization Platform:
1. Asset Onboarding—The Asset Monetization Platform provides easy onboarding of assets. The proprietary algorithm allows owners to monetize these assets through the automation of their lifecycles. Through an innovative user-interface and self-help tools, assets can be fractionalized, priced, and, through multi-signature verification, validated as carbon credits. They can then be tokenized and placed for sale onto the platform.
2. Monetization Platform—The primary processing engine of the Asset Monetization Platform consisting of the Smart Contract, Digital Transactions, Immutable Ledger, Asset Dashboard, and Tracking & Tracing. The monetization platform not only tokenizes and provides the full trading capability of the assets, but it also provides monitoring and reporting capabilities throughout the lifecycle of the asset.
3. Payment System—a comprehensive yet flexible payment system ensuring that all transactions are secure and safe and removing friction from the payments process. In addition, a simplified KYC process is made available with face-recognition software.
4. Data Layer—a comprehensive data format that includes asset-level identification and status data in addition to industry-level common components. The data is organized into sustainable development goals and e-reporting by geographic and government information, and has an API layer, data validation layer and is divided into multiple data repositories based on data type.

### Smart Contract

Leading blockchain technology provides the framework for the MCC-1 Token. The Smart Contract programmatically enforces the onboarding and management of carbon credits during their lifecycle.

Automated rules that determine carbon credit certification are built into Smart Contract algorithms. These rules encompass the four carbon offset project categories listed above and include all project types.

Carbon Credit registration and multi-signature verification is built into the Smart Contract. This ensures that all certification requirements to be an MCC-1 Token are met and that integration with any third-party carbon credit registries are also met.

It is crucial that carbon credits are retired once they have been used. The Smart Contract documents the retirement and communicates to any third-party registry.

Metadata tracks all carbon footprint reducing activities and carbon credit distributions including all technical and processed financial transactions. All identification, certification, and transaction data are stored as part of the MCC-1 Token. Additional data, including detailed monitoring and audit data will be identified via a link in the Smart Contract and stored off-chain.

### Algorithms

The MCC-1 algorithms are an innovation that will be built into the platform's smart contract automating the rules for carbon credit certification. The algorithm variables will be set based on the Project Category and Project Type. The variables will also be weighted based on type. As the platform evolves, the machine learning algorithms will process updated data consistently. The variables in the algorithms consist of the following:
Reduction in CO2 or Life Cycle Greenhouse Gas Emissions (GHG). This is one of the primary requirements to carbon credit certification. A threshold amount of reduction will be required, by project, to be certified. As an example, for Sustainable Aviation Fuel, the variable would be set to a minimum of a 30% reduction in lifecycle CO2 and greenhouse gas emissions up to 2030 and a 50% reduction by 2040. To that end, several companies are investing in Direct Air Capture (DAC), with the goal of achieving capture costs of $100/tCO2 to $150/tCO2 by 2030, 60 to 80 percent less than today's pilot projects. Low-cost DAC, coupled with low-cost hydrogen, could enable production of carbon-neutral e-fuels in the near to medium term.
Annual Carbon Credit Production Target. The carbon credit production target on an annual basis ensures that the offset project is substantial enough in size and will continue to produce on an annual basis. Identification of state-of-the-art, patent or patent-pending technology proving carbon reduction and/or the reduction of GHG. Requirement includes the validated capability of delivering carbon reduction of over ‘x’ emissions or ‘x’ percentage reduction resulting in the production of ‘x’ no. of carbon credits/year for the program.
Cost per Unit of Emissions. Climate technologies must compete with existing technologies based on cost, efficiency, performance, and other attributes unrelated to their environmental benefits. High cost can be a significant barrier to widespread uptake. With the sustained demand for these technologies, producers can create production efficiencies resulting in reduced costs. The algorithm will be determined from a ‘not-to-exceed’ target. For example, from now to 2030, electric vehicle lithium-ion battery cost per megawatt hour is expected to reduce by at least 23%. By 2070, the cost of the average battery is expected to drop by 68% in the Sustained Development while gravimetric energy densities at cell level increase by 160% compared with current levels. Continued price monitoring and changes will be added to the algorithmic calculations to ensure efficiency.
Compliance with the MCC-1 Standard. To comply with the MCC-1 Standard, the carbon offset owner will run a prototype under average expected conditions and at scale based on the product definition. The owner must also forecast the cost to complete the innovation, demonstrate the ability to quickly deploy new types of equipment & infrastructure required for commercial rollout, and prove validity of the rollout plan.
Test Criteria & Certification. This calculation includes ensuring critical test criteria have been covered, the availability of funding for continued testing and the testing stage. For example, it is necessary to test properties for fuels produced from other materials, such as renewable feedstocks, to determine if the alternative jet fuel is acceptable for use on current or future technology aircraft and engines. These tests cost up to $50,000 (ASTM, 2018) and may require up to 100 gallons of fuel (ASTM, 2018). A proprietary calculation comes up with a calculation based on the three criteria mentioned above.
Capital Availability. A commitment to investment required for commercialization growth and innovation over the next ten years—not only through research and development (R&D) and demonstration but also through deployment—needs to be accompanied by the large-scale construction of the infrastructure the technologies will need. An estimate by Mckinsey, states that five groups of technologies could attract $2 trillion of capital per year by 2025 and abate 40% of green-house emissions by 2050.
Clearly, emissions reduction will require enormous investment from a global coalition of actors. Any offset project will have to provide detailed funding plans. A calculation will be based on a) target estimates for research up to commercialization of target emission plans; b) fund target review; c) percentage of R&D funding available; d) breadth of tools and sources used for funding—from public research and development to market incentives, both private and federal funding programs; c) targeting innovation at areas of the supply chain where necessary.
Channel-Specific Additions. The various carbon offset categories and projects will possibly include additional requirements for certification. As an example, Forestry projects require confirmation of permanence and additionality and require ongoing monitoring to prove the legitimacy of certification. See below, for the channel-specific additions by category.

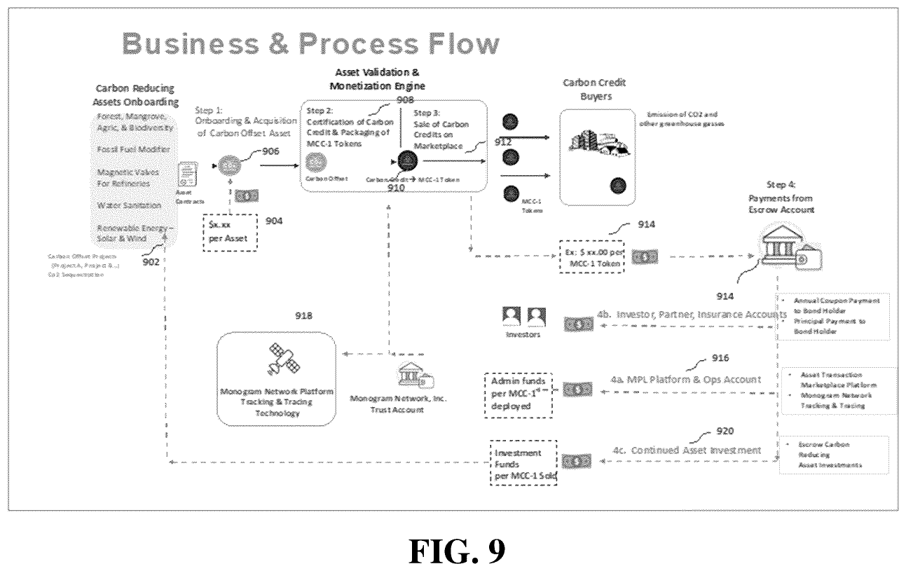

FIG. 9 shows the asset types currently supported on the Global Asset Marketplace including-Forest, Mangrove, Agric, & Biodiversity, Fossil Fuel Modifier, Magnetic Valves For Refineries, Water Sanitation and Renewable Energy—Solar & Wind 902. The are carbon offset rights are purchased by Monogram 904 and are processed, validated and certified through the Asset Monetization Engine 906, tokenized into an MCC Standard 908 and placed on the Asset Marketplace to be sold to Asset Buyers 910. Monogram receives a $x.xx per token 912 and distributes a portion of it to their Payment Agent 914. The Payment Agent pays the insurance provider, investors, and additional partners. With the remaining proceeds, Monogram distributes it for reinvestment into monitoring technology to enhance the quality of the assets 916 and platform and operations to enhance the customer experience 918 and reinvests a substantial percentage into additional assets 920.

The first major function is asset identification and investment which is the identification of assets for onboarding to validate for investment. Machine learning and AI are part of the asset investment and supply chain strategy with an engine that looks across the world market to find attractive asset candidates based on selected criteria. The neural network system identifies technologies and companies based on input metrics. These metrics drive the system to find activity from asset sources that are contextually relevant to the specified parameters. It then retrieves data from identified data sources and launches a custom intelligent bot to crawl conversations. Targeted sources of data include asset-specific industry sources, proprietary social media data via public APIs, and partner-recommended sources automatically integrated into the data layer of the platform. The desired subject matter is mapped in a hierarchical structure where a scoring algorithm is applied for relevance. Once interested sources are identified, communication bots can be integrated to further source the data.

The validation process of each of these carbon offset assets follows a specific, proprietary protocol. Requirements for this stage includes:
1. The Carbon Offset project falls into an MGN platform project and asset type including but not limited:
   Forestry
   Carbon Reducing Technology
   Fossil Fuels
   Sustainable Innovations
2. Preliminary data confirms that carbon offsets will be validated as carbon credits.

The second major function is asset onboarding. In asset onboarding, an asset provider completes an asset sales agreement to onboard the asset into a Digital Assets Warehouse. It identifies responsibilities, rights, and obligations to manage project risks. This agreement is a long-term agreement, depending on the asset, covering from 5 years to 20+ years.

The third major function is certification of assets which assesses, verifies, insures, certifies, and tokenize assets. Algorithms are automated on the MGN Platform to validate this process. A partnership with the asset seller to verify the:
1. Asset unit definition—The asset definition includes a) a detailed unit definition, b) a basic unit definition (i.e., one token=one [asset], c) A threshold amount of reduction will be required, by project, to be certified.
2. Annual Carbon Credit Production Target—The annual production target of the asset ensures that the project is substantial enough in size and will continue to be produced on an annual basis. This target includes the validated capability of delivering the quantity and, as appropriate, type of asset. As an example, the delivery of carbon reductions of over ‘x’ emissions or ‘x’ percentage reduction resulting in the production of ‘x’ no. of carbon credits/year for the program.
3. Cost per Unit Emissions—A variable the platform algorithm calculates is the cost of the asset. The assets must compete within the industry and with related assets on cost, efficiency, performance, and other attributes. Industry data is built into the data layer for evaluation and comparison. Climate technologies must compete with existing technologies based on cost, efficiency, performance, and other attributes unrelated to their environmental benefits.
4. Compliance with the Asset Token Standard—to ensure compliance with the Asset Token Standard, the asset owner runs a prototype under average expected conditions and at scale based on the product definition.
5. Test Criteria & Certification—This calculation includes ensuring critical test criteria have been covered, the availability of funding for continued testing, and the testing stage.
6. Capital Availability—A commitment to investment required for commercialization growth and innovation over the next ten years accompanied by the large-scale construction of the infrastructure the technologies will need.
7. Channel-Specific Additions—The various asset categories and projects will include additional requirements for certification.
8. Reduction in CO2 or Life Cycle Greenhouse Gas Emissions (GHG). A threshold amount of reduction may be required, by project, to be certified.

The final step of the third major function is the tokenization of the asset into tokens on the asset blockchain warehouse. That is, the tokenization of the carbon offsets into Carbon Credit MCC-1 Tokens on the carbon credit blockchain warehouse.

The fourth major function is the MGN platform marketplace. Monetization is the positioning and providing of the carbon credits on the MGN Platform Marketplace monetized and deployed to entities wanting to use carbon credits to meet their company environmental goals and carbon offset. A carbon credit purchase agreement will complete the transaction of carbon credits/MCC1s. This agreement may be of a revolving one-year term.

The present disclosure is accelerating growth by implementing a proprietary algorithm and AI marketing platform which will lead to rapid expansion and adoption of the marketplace. This solution scans for selected criteria and conversation interest in the identified asset. It may also use a neural network to map and score sources for relevancy. It takes a deeper step to not only target interested organizations but to look for target users and potential influencers based on the data. A Targeted Communication Manager may then be introduced to distribute a targeted communication either to a group of influencers or to a specific user. An AI Bot may continue engaging through the use of targeted ads. An effectiveness monitor measures the effectiveness of the targeted ads delivered based on subject matter searching.

A user evaluation system may map the user's impressions and level of interest with the ads and targeted messages. Finally, the AI agents may then interact with the targeted users with one or more actions that may be taken based on the user's on-going engagement with the agent.

The platform may have a built-in automated financial services virtual ledger to simplify the trading function. The platform has ‘broker-dealer’ expertise built into the platform, mitigating the need for 3rd party manual intervention. This module automatically provides:
Online onboarding through a streamlined KYC process,
Global payment processing,
Crypto/fiat conversions,
Same day settlement, processing,
API integration with the network financial services partners, and,
A payment agent for payout confirmations.

The fifth major function is AI and Satellite Monitoring. The use of Artificial Intelligence (AI) monitoring and machine-learning technology plays an important role on the MGN Platform as a key component of the ongoing monitoring and tracking and tracing of the asset and through the use of blockchain oracles to ensure the validation of both the asset through its lifecycle and of any asset owner payment and client payout. It provides data on the carbon credit sourcing including the project location, date it became a carbon credit and was purchased, and all audit results undertaken to validate it as a carbon credit.

Satellite monitoring is of specific interest with specific asset types, such as Forest carbon credit assets, as a way of monitoring the forest land. It provides for the tracking of permanence (the longevity of removal enhancements and the risk of reversal (i.e., the risk that the emission reduction benefit will not be permanent) where the requirement is a minimum of 20 years) and additionality (emission reductions or removals would not have occurred without revenue from the sale of carbon credits which is intrinsic to the environmental integrity of a carbon project.).

Tracking and Tracing displays the entry of every commodity purchase and trading transaction onto the blockchain, the ownership and history of each asset, validation/authentication of the owner of each asset through a streamlined KYC process, and the location (GPS) of each asset.

Carbon Asset Investment—The cycle of the entire Token repeats with the investment of the proceeds into additional assets. This ensures not only the continuity of the program, but investment volumes increase automatically with each MGPC cycle.

### Carbon Offset Project Categories

The present disclosure embodies the economy and process of assessing evaluating and ensuring true carbon credits from any genesis including but not limited to:
Carbon Reducing Technology
Net Zero Economies
Forestry
Sustainable Innovations

Each carbon credit vertical may store multiple projects representing MCC-1 Tokens for review and selection.

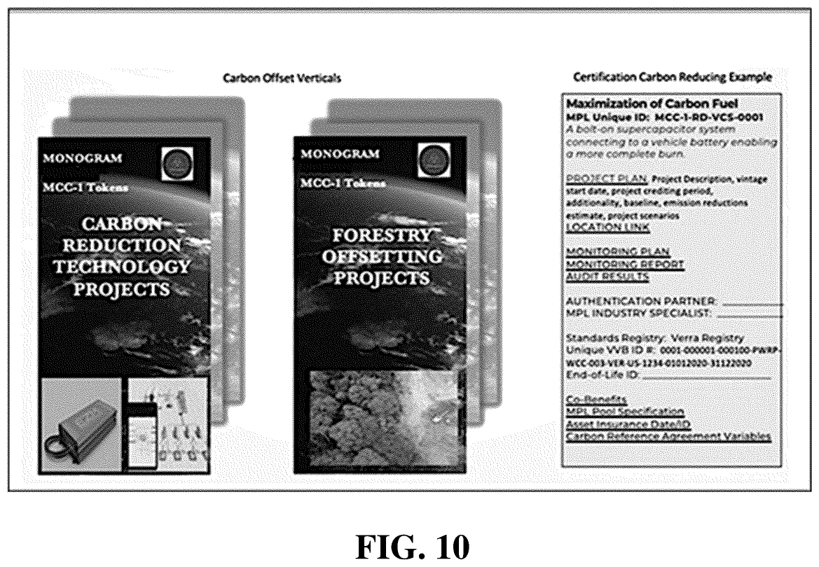

FIG. 10 illustrates the Monogram Project CARDS using Carbon Offsets as the Asset-type. The first two diagrams show a UI example of a card by project-type showing a number of additional cards of the same type behind it for automated selection. The third diagram shows an example of type of information within a card. Asset selections used to guide Asset Owners in the project detail and ownership requirements and Carbon Credit Buyers in the Assets that are available on the platform in accordance with the principles of the present inventions. (NOTE: The detailed fields may change based on Asset-type and as the projects mature.)

The present disclosure of the asset monetization warehouse and economies platform can operate with the IoT Internet of Things, Media Platforms, and all Universal Platforms. Each platform is designed to issue an unlimited amount of assets or specific product of a specific market segment for a specific marketplace. Examples includes, but are not limited to:
Media—Each song and movie will be embodied in one asset which includes its ownership, royalty splits, retail pricing and retail media streaming capability.
Citizen of the World—Each person on planet earth and the universe can get issued a personal asset which embodies undeniable identification to each person. Those assets are issued from the asset warehouse platform and can trade on any exchange.
Carbon Credits—Issuance of true carbon credits with 1 tCO2 sequester per carbon credit.

The present disclosure deploys the first global marketplace for automated, secure asset monetization and is working to redefine the way global assets are purchased and sold.

This present disclosure deploys a global marketplace for fully automated, secure asset monetization demonstrating the future of Global Assets. The platform is changing the investment landscape by providing unprecedented access to historically unavailable assets. This is paving the way for the future of all assets and commodity trading by introducing a digital marketplace that provides exclusive ownership of select assets, secured by leading public ledger blockchain technology.

Using this highly transparent technology, it creates an opportunity for the user to capitalize on the highest-growth periods of asset lifecycles, to maximize client returns with negligible risk. Investment communities are realizing opportunities in fractionalized asset ownership through a self-directed investment platform. The products have a variety of safeguards in place to ensure that returns are protected and insured for maximum peace of mind, each of which we will walk through in detail.

The asset investment opportunities are extensive. Investment opportunities include, but are not limited to carbon credits, media assets, real estate, gold, oil, gas, new energy assets, certified prime whiskey (commonly referred to as “Liquid Gold”), cannabis, gold, precious stones, (i.e., diamonds), art (paintings & digital art), intellectual property (patents & copyrights), and internet domain names. Financial returns vary by asset and range from 10-70% annually, depending on the client's choice of product.

The present disclosure ensures full transparency and security. Every asset unit, asset location, asset registration, asset status, asset transaction, asset retirement, user transaction, user history, user data, and financial transaction, is recorded with full transparency on the immutable ledger. It insures all assets with carriers [such as Lloyds of London and AIG]. Depending on the asset, it will also deploy the world's largest and most highly respected inspection auditor, SGS, and even insure the token holder's annual return. In other words, the investment performs much like a Treasury Bill and carries negligible risk, but with a higher return. The goal is to design financial products with no downside—only upside.

The Asset Monetization Platform innovation is the key interface to the marketplace. Innovative features of the platform include: a fully self-service marketplace, fully automated onboarding, leading asset standards across multiple industries, Smart Contract automation offering multi-signature verification and asset registration, a fully digital asset transaction cycle (trading/selling/retiring), self-help tools (i.e., asset pricing), frictionless payment processing, streamlined KYC processing, blockchain innovation, comprehensive security features including token insurance, tracking & tracing advances with integrated monitoring sensors, and, award-winning AI functionality for business targeting. The platform provides flexible asset onboarding and tracking & tracing of each asset through its lifecycle, serving as a concrete historical record. The proprietary platform provides a self-service, interactive commerce experience which gives clients real-time information on the status of their assets throughout the entire investment lifecycle. Clients can see all relevant details of their assets real-time including location, growth rate, pricing algorithms, industry certification, transfer & trading rules, liquidity events, settlement processing, and live auditing data. To keep each client's contract safe and secure, the platform records it on a decentralized, immutable online ledger, which utilizes leading blockchain technology.

To summarize—the present disclosure provides a simple, secure, and low-risk investment products that allow clients to profit from assets and industries that were previously available to only large institutions and the savviest clients. The product was designed to ensure that clients receive consistent returns and are exposed only to the upside period of the asset lifecycle. Never has it been easier, safer, or more exciting to invest in appreciating commodities, and we look forward to welcoming you to the unique Asset Monetization Platform experience. (See Diagram B)

### The Journey to Net Zero

The world is coming together to reduce the carbon footprint of our planet. Rising temperatures are causing extreme weather, tropical storms, wildfires, and severe droughts. Our oceans and waters are no longer clean and blue due to carbon emissions which have dramatically increased CO2. Even with global efforts to reduce CO2 emissions, it recently reached an all-time high of over 58 Giga Tons.

Through the elimination of unnecessary middlemen and the tokenization of carbon credits, this invention is creating a very aggressive Carbon Footprint Reducing Economy by pushing and accelerating carbon reducing industries. All carbon footprint reducing activities and carbon credit distributions, including all technical and financial transactions, are processed through blockchain technologies. The deployment of these carbon credits generates proceeds which can be invested into additional carbon offset initiatives, introducing a repetitive cycle and bringing the world substantially closer to achieving carbon neutrality and ensuring that our planet is preserved for generations to come.

### MCC-1 Token Standard

MCC-1 is the next level in innovation by providing the world access to transparent, verifiable, and environmentally robust premium quality carbon credits leading the Journey to Zero. It entails a fully digital process where carbon offsets are verified and issued through its patent-pending MCC-1 Token. MCC-1 provides standardization across the global marketplace.

This global marketplace will provide a blueprint for validating and scaling of the carbon market by streamlining the carbon offset onboarding and MCC-1 certification process. The blueprint consists of the following:
The creation of core principles and standards for defining and verifying carbon credits.
Registration aggregation across leading standards parties.
The development of standardized reference contracts for carbon trading combining a core contract with additional attributes defined according to a standard taxonomy and priced separately.
The establishment of a complete trading infrastructure ensuring simplified onboarding and a broad data infrastructure promoting the transparency of reference and market data.
Sophisticated Tracking & Tracing ensuring the legitimacy of the carbon credits through the entire lifecycle.

Proceeds may be invested into long-term contracts in forest management and carbon-reducing infrastructure providing consistent opportunities for growth and expansion.

All processes and data are secured by the prime quality carbon credit standard—MCC-1. It is insured by A-rated insurances.

One MCC-1 Token is equivalent to one ton of CO2 emission. The carbon credit tracking, verification, and metering is routinely audited with full transparency in a patent-pending secure online format. Artificial intelligence is added as part of the supply chain strategy and will evolve based on our assets, sensors, and customers.

Bringing the world substantially closer to achieving carbon neutrality and ensuring that our planet is preserved for generations to come.

The MCC-1 application uses an innovative card design to display carbon projects allowing both, buyer and provider to easily access carbon offset projects with specific co-benefits and technology. This card-based design features both a summarized view and pre-approved offset methodology details depending on the application user's objective. MCC-1 provides price transparency with targeted customization while ensuring superb quality.

### Carbon Offsets

Before a carbon reduction becomes a carbon offset and gets minted into an MCC-1 Token carbon credit, it must meet a set of criteria based on methodologies outlined as part of the MCC-1 carbon standard. There is a validation and verification process required to validate a Carbon Offset. This starts with a Carbon Offset Project. Available through the MCC-1 Tokens, are a unique set of carbon offset projects. As an example:
A revolutionary zero-carbon, circular economy
Battery technology eliminating carbon monoxide in automobile emissions.
Afforestation, reforestation, and improved forest management in some of the largest forests on the globe.

Collaboration occurs between many industry partners and works across multiple verification standards and registries. A validation process is specific to the MCC-1 Token. At the most summarized level, this process validates and documents the following elements of a carbon offset project:
Baseline scenarios—ensuring a valid method of which to measure emissions;
Monitoring process—required to continue validation of the carbon credit through the lifecycle;
Methodologies—for calculating emission reductions.

The objective of the MCC-1 Token validation process is to combine quality and integrity of the carbon credit certification process with speed and flexibility. Eligibility requirements detailed in the project plan includes:
Project Term—Carbon Offsets require validation over a sustained period, or ‘permanency’ as it is defined. Based on the project start date, the Project Term must meet the requirements based on the project type.
Crediting Period—the Crediting Period is the length of time for which a Carbon Offset Project Plan is valid, and during which a project can generate offsets against its baseline scenario. Consistent monitoring throughout a lifecycle is required to reconfirm that the baseline scenario remains realistic and credible, the Project Activity remains additional, and that carbon emission accounting best practices are being used.
Emission Mitigation Methodology & Measurements—emission reduction activities must be verifiable and measurable and use an accepted methodology depending on the project type. As an example, activities cannot be accepted based solely on forecasts.
Permanence Validation—permanence refers to the longevity of removal enhancements and the risk of reversal (i.e., the risk that the emission reduction benefit will not be permanent).
Additionality Validation—additionality ensures that the project plan improves the current performance standard and that the reduction wouldn't have happened regardless of this project. Testing must ensure that the current performance standard is being exceeded by a certain measure, as defined in the applicable methodology, and that it meets a regulatory additionality test.
Leakage Validation—ensures that no decrease in emissions or in sequestration outside the project boundaries occurs because of the project action.
Offset Rights—evidence that all emission reductions are clearly owned by this project and that additional owners, projects, etc., cannot also claim the same reductions.
Regulatory Compliance—Adherence to all laws, regulations, and other legally binding mandates directly related to Project Activities.
Third-Party Validation—To ensure best practice measurements and industry acceptance, the MCC-1 Token validation process requires third-party validation and multi-signature verification as part of the carbon credit Smart Contract process.
Monitoring and Risk Management—All projects must validate a routine monitoring/tracking & tracing plan and ensure that required risk management is taken. The platform provides tracking & tracing of the asset throughout the lifecycle including, as appropriate, satellite monitoring of the land and its uses based on the plan.
Co-Benefits—A listing and brief description of any co-benefits, i.e., local economy employment, to be used to a) enhance the carbon offset project plan and increase the project's potential; b) as a variable in the pricing of the carbon credits; and, c) to market to potential carbon credit buyers.

Each registered project is automatically assigned to a carbon credit expert/validator (depending on multiple variables including project type, location, availability, etc.), responsible for working with our third-party partner network ensuring that the necessary eligibility requirements are met.

All project descriptions must be validated against the MCC-1 standard, and platform rules, and project validation reports must be submitted for final multi-party authentication.

Additional pre-established MCC-1 standard rules will be identified as part of the project document including but not limited to a) having the carbon credit buyers publicly disclose commitments and transition plans and annual progress to decarbonize; b) measurement and gas emission reporting on an annual basis; and c) sharing all MCC-1 carbon credits purchased and retired.

### Asset Onboarding

The Asset Monetization Platform provides easy onboarding of assets. The proprietary algorithm allows owners to monetize these assets through the automation of their lifecycles. The platform provides certification documentation and visibility of asset availability and full transparency for buyers.

Examples of assets hosted on the Asset Monetization Platform, both tangible and intangible, include intellectual property (patents & copyrights), internet domain names, carbon credits, real estate, music, entertainment, precious metals, diamonds, cannabis, art (both digital and paintings) and premium whiskey and drinks.

The Asset Management Platform will also provide the asset owners with updates based on pricing history, demand, industry valuation, etc.

Using a proprietary, AI platform, market interest in carbon offset assets and buyer targeting will be provided via a social targeting platform.

### Monetization Platform

Smart Contract—A key component of the Monetization Platform is the Smart Contract. The MCC-1 Token buyer can think of the Smart Contract as their guarantor of payments, because the activation date and payment terms are clearly spelled out on the token's associated metadata.

There are multiple Smart Contract innovations designed to simplify the asset validation process while ensuring asset quality and registration. These innovations can either be integrated into a Smart Contract or divided out into multiple Smart Contracts.
Smart Contract Innovation #1—Smart Contract Registry—A registry system on the Blockchain to record the essential Carbon Offset Project metadata.
   Validation of essential information for key stakeholders including:
   a) 3rd Party Validators: Partner experts that validate carbon credits from the Carbon Offset Projects. They also verify that the quantity of MCC-1 Tokens burnt are equivalent to burning a proportionate number of emissions.
   b) Offset Project Owners: Governments, forest owners, and carbon offset project owners that hold carbon offsets in the emissions trading ecosystem.
   c) Carbon Credit Customers: Corporations interested in offsetting their carbon footprint by buying carbon credits and burning the carbon token.
   MCC-1 will register the provider's projects and buyer purchases through a carbon reference agreement (a core contract, based on standards with additional attributes that are defined according to pre-established taxonomy and priced separately. (The MCC-1 application guides the user through the onboarding and process through application features and tools.)
   The MCC-1 Token certification, and insurance information and asset security certifications, including any from 3rd-party sources or registries, are built into the Smart Contract and attached to each token or pool of tokens.
Smart Contract Innovation #2: Identification and Automation of Rules to manage the minting of MCC-1 Tokens based on validated and approved carbon credits through a series of functions:
a) The onboarding of Offset Credit Projects and carbon credit validation.
b) Pricing and payment rule assignments.
c) Rules for Minting the MCC-1 Token.
d) Rules for transferring and retiring the MCC-1 Token.
e) The minting or documentation of token retirements as a badge of successful burning carbon tokens, representing offsetting carbon emissions.
f) The Recording of all ownerships and changes across transaction steps.
   The use of blockchain oracles, monitoring data and/or measurements will trigger Smart Contract updates, and some payments, based on MPL asset pre-contracted terms.
   All rules associated with the trading of the tokens, such as the retirement of used tokens and the prevention of immediate resale, are baked into the Smart Contract. When retiring the MCC-1 Tokens, the purchase location is referenced for accurate Paris Agreement accounting.
Smart Contract Innovation #3: Multi-Signature Verification of the MCC-1 Token—this multi-signature feature allows the experts to validate the MCC-1 Tokens and verify the minting and retirement steps. An automated process requires multi-signature approval for automatic execution.
Smart Contract Innovation #4: Automated Trading and Recording of the MCC-1 Tokens integrated with the payment system (using fiat currency) with transaction fee distribution (as appropriate) and dynamic price discovery for the MCC-1 Tokens in a free market.
   The Smart Contract is built for future flexibility across stable coins, multiple wallets, and exchanges.

### Digital Transactions

This function of the Asset Monetization Platform encompasses the minting, trading, and burning of MCC-1 Tokens.
Completed and validated Carbon Offset Projects will receive multi-signature verification, minted as MCC-1 Tokens, and distributed over the global marketplace.
The MCC-1 Token Definition is: One MCC-1 Token=One insured premium carbon credit=One Metric Ton of Greenhouse Gas Removed
MMC-1 Tokens can be purchased through a combined selection of project customization, price, and location from the Asset Monetization Platform global carbon credit portfolio (pool).
Minted MMC-1 Tokens can be tracked for status via the secure platform dashboard.
Each MCC-1 Token or Token Pool will have a unique ID for historical tracking.
All MCC-1 Tokens will follow proper retirement rules and receive a retirement certification.

### Immutable Ledger

The priority is protecting clients' purchases. The investments are safeguarded in multiple ways which starts with the platform's use of immutable logging, tracking and tracing of the assets. The immutable ledger uses a combination of cryptography and block interrelationships, making the blockchain database highly secure.

Using blockchain technology, the Asset Monetization Platform provides a permanent and unalterable history of the minting, trading, and burning of the MCC-1 Tokens.

### Asset Dashboard

The dashboard feature on the Asset Monetization Platform provides onboarded assets with real-time updating of acquisition, asset status, and payment status. Each client receives access to a confidential dashboard storing data specific to their transactions. A summary of the data available includes:
Financials—Complete acquisition data (asset quantity, total purchase price, redemption date/amount, status of any financial transactions, disclosures), account balance, payouts, target yield, and upcoming payments.
Timeline—Acquisition date, activation date, payout date(s), retirement date.
Asset Status—Description of the asset and IoT sensor data on environmental and asset status. Historical status of assets.
Industry—Performance of the industry and specific asset, projected value, future value.

Asset validation and certification from reliable third-party sources are prominently shown on the platform dashboard. (See Diagram C)

MGN Platform Sample Asset Dashboard

### Tracking and Tracing

A highlight of the Asset Monetization Platform is the extensive tracking and tracing capabilities of the onboarded MPL Assets
The platform will provide the tracking of MCC-1 Tokens and pools of MCC-1 Tokens by customer, by project, by location and by date as part of the historical ledger.
Tracking the date of the asset purchase, the asset location, asset status and confirmation in the asset inventory.
All Carbon Offset Project detail, MCC-1 Token validation and registration, and retirement documentation will be provided via a report should any external audit be required.
Each MCC-1 Token purchase and trading transaction including ownership and history of each carbon credit will be tracked.
Routine audits and/or measurement validations confirming asset specifics.
Tracking and tracing of the transaction's monetary flow across both fiat and cryptocurrency.
Monitoring tracking of the emission reductions and project performance through our global satellite monitoring rights ensuring no leakage and carbon reversals.
Each retirement will be ‘certified’ and tracked on the platform and reported to the corporation, the appropriate third-party registry and be made available to the government where the offset project initiated.
A ‘visual’ view of the MCC-1 Token may be available if it shows major forest land improvements, etc. In addition, machine learning algorithms will be applied to satellite imagery and sensors for faster and more exact analysis and identification of risk mitigation.
Integration of innovation, including LiDAR technology, to better track spatial distances via laser illumination.

### Payment System

A critical component of the Asset Monetization Platform is a comprehensive, yet flexible, payment system. The two primary drivers behind the development of this payment system are ensuring that all transactions are secure and safe and removing friction from the payments process. While payment speed is important, the payment system also ensures security through the implementation of a Know Your Customer (KYC) best practice remediation process. The goals of this include rewarding clients, improving data quality, and prioritizing cost and time.

The closed-loop system will provide a comprehensive set of global payment solutions in fiat and cryptocurrencies. The system will combine market access (ATM, POS, mobile, merchants, channels) with transparent and simple pricing, expansive payment market integrations and extensive compliance with minimal friction thereby delivering same-day settlement processing and will carry all global monies (as approved by the government) and widely used cryptocurrencies.

Payments to registered addresses will be documented on-chain to provide an open and reliable means of confirmation, whether they are made to a wallet address in stable coin or a bank account in fiat.

### Data

The Data layer of the Asset Monetization Platform standardize the methods and protocols, as well as the systems for acquiring, storing, managing, and sharing data across the platform for improved decision-making. The data includes a combination of individual transactional data, asset data, broader industry data, and data standards within the carbon industry. The architecture includes standardized and consistent data as an integrated layer of data and connecting processes for real-time analytics with the data residing across distributed environments. It is running on a cloud infrastructure and has a data verification over, at minimum, four to an unlimited number of data layers consisting of, at minimum, a) Public Data; b) IoT Data integrating sensors and actuators; c) Private Data and Repositories; and d) Industry Standards Data.

### Additional Asset Monetization Platform Features

The platform further provides: (See Diagram D)
Innovative User Interface—An innovative user interface with specific carbon offset project cards detailing all pertinent project plans, documentation, and certifications.
   For Asset Onboarding, existing project card details and proprietary MPL estimation tools will be utilized to assist in the completion of the MCC-1 project document.
   Shopping Cart—For flexible purchase agreements and checking-out capabilities.
Product Inventory Management—The Asset Monetization Platform pools carbon projects and associated MCC-1 Tokens into carbon categories and stores them under the carbon verticals to provide scale and average pricing.
Location Services—Through the application's interactive global map, the app user can target specific areas and selected GPS coordinates across the globe for carbon offset project investments.
Templatized Purchase Agreement—The MCC-1 Standard will register the provider's projects and buyer purchases through a carbon reference agreement (a core contract, based on standards with additional attributes that are defined according to a standard MPL taxonomy and priced separately. (The MCC-1 application guides the user through the onboarding or purchasing process through application features and tools.
Project Co-Benefits—MCC-1 highlights project co-benefits (local job growth, improved community health improved water efficiency, etc.) integrated within the project cards.
Industry Standard Data—participating with various industry partners in establishing carbon standards and historical project performance and risk assessments offering transparent industry reference data within the MCC-1 data infrastructure.
The Carbon Credit Process flow shows the critical steps of the platform and how the majority of proceeds go back into the purchase of additional carbon offsets. This allows buyers to be key partners with each asset.
AI Marketing Tool—AI will identify corporations and individuals that have demonstrated interest in carbon credits and identify audiences most likely to purchase carbon credits. Through this proprietary AI marketing engine, we gather and organize social media input maintaining a robust source of carbon credit buyers.

### Media & Entertainment Warehouse

The creation, production, distribution, marketing, trading, and consumption of music an asset.

Today's Challenge—Today, music is distributed globally by digital retailers such as Apple Music, Spotify, Amazon, YouTube/Google, and others. For decades, these providers have been routinely accused of treating content creators poorly through duplicitous contract structures and low payments. Creators often relinquish ownership rights to platforms in the initial contract and have difficulty tracking where their content is subsequently distributed. A recent Citigroup report indicates that musicians only retained 12% of $43 billion generated in the industry in 2017. This alarming statistic proves that while the industry is still a profitable enterprise, the musicians who actively generate that value are left as starving artists. Sadly, most artists have no idea what they should be receiving or what is fair payment. Needlessly complicated payout structures are hopelessly confusing for artists and rights owners.

The streaming platforms are essentially at the nexus of modern music distribution. However, while in some cases they have helped to empower independent artists, their overall domination undercuts decentralization, which in turn affects artists' revenues. As such, the introduction of non-fungible tokens (ASSETs) to promote transparency and consensus in the sector provides an opportunity to empower artists globally.

### Introduction of a Paradigm Shift in Producing and Consuming Music

### The ASSET Media & Entertainment Warehouse

Another example of this invention is the creation of the ASSET Media Warehouse, marking a paradigm shift for content distribution and consumption.

Through the ASSET Media Warehouse, fans can easily follow and support their favorite artists. Content creators will onboard their content to the ASSET Media Warehouse. The platform provides simple, automated onboarding of the asset, and a proprietary algorithm allows asset owners to easily monetize their assets. The platform then provides visibility of asset availability and full transparency for buyers.

The platform: a) gives the creator FULL control of the assets in the global market and, b) connects creators and rights owner directly with the consumer without any middleman, whole seller, retailer, or any agent otherwise!

Once the onboarding process is complete and the content is uploaded, everything is on autopilot for the content creator. This includes global distribution, AI marketing, client (consumer/fan) relationships, the pricing model (history & industry reflections), the sales mechanism, income tracking, accounting, auditing, and internal royalty distribution. Control is restored back to creators through new and enhanced income streams, motivating the artists to produce more appealing content. Creators can retain ownership by baking it into the ASSET. If the creator then decides to relinquish the rights to a song/album, they will automatically receive royalties, and this process continues each time the ASSET is sold. Creators can also mint additional ASSETs such as digital versions of signature accessories and other collectibles.
1. AI will connect content creators and consumers directly so that wholesale or retail sales are not necessary. Once again, we are cutting out the middleman and providing four billion consumers with exactly what they want.
2. Direct client/customer/fan relationship management—The ASSET Media Warehouse allows for unprecedented direct interaction between consumer and creator. For the first time, content creators will engage directly with their audience and learn exactly what they want. ASSETs present opportunities for musicians to engage with their audience on a more granular and authentic level, establishing new communities and giving them complete autonomy over their work.
3. A digital rights database implemented on the blockchain.
4. Additional opportunities—Several additional opportunities will be made available through the MEDIA ASSET. These include introducing scarcity using limited offers, providing influencer rewards, and encouraging fundraising through royalty sharing.

### The Media Asset

For each song and/or album, the creator will deploy one Media Warehouse ASSET. The creator will be provided with a tool to uniquely package and furnish the MEDIA ASSET with all possible data connected with the song, as well as all related legal agreements. Data that can be connected with the MEDIA ASSET include:
Ownership rights
Payout value and history
Artist, musicians, band members (also, through photo cards)
Composer, producer, publisher, record label, studio, director
Related merchandise (both digital and retail)
Related films, TV shows, actors/actresses, games, social media community
Payout and associated calculated payout split
Audience details.

In summary, the MEDIA ASSET will include the entire legal, financial and media universe associated with this song. This MEDIA ASSET will be owned by the creator and issued onto the Asset Monetization Platform. Here at this one MEDIA ASSET is the ONLY point where the entire world can interact with this one song.

The MEDIA ASSET has one more value: once it is launched on the trading network, it will get fractionalized into 1,000, or 10,000 MEDIA SUB-ASSETS, which can then be traded on the global markets.

### Global Distribution

Global distribution is transparent as the MEDIA ASSET's media will link out to the world's central server Fuga, with either direct access for the consumer, or through any retailer such as Apple Music, Amazon, Spotify, NetFlix, etc.

### Marketing Through AI

AI will provide the talent community with information on what type of entertainment audiences are seeking out, giving them direct access to their fanbase. AI will then identify audiences best tailored for each artist's music. Through this proprietary AI marketing engine, we gather and organize social media input into artist communities:
1. As a marketing tool to look for additional interested candidates based on artist familiarity and likeness, type of music, specific songs
2. As a tool to analyze consumer interest levels regarding artists, specific songs, music type, and venues
3. Act as a communication agent to market new songs, tours, products, etc., using expertise such as temporal technique (time of day)
4. As an additional research arm for the music industry

### Pricing and Financial Services

The Media ASSET Media Warehouse allows for the unprecedented management of funds, royalty streams and business splits for every song and every piece of media. All aspects of the process are managed via a Smart Contract. As part of the onboarding setup and financial reporting for the creator, a song or album of songs will be tracked through the entire lifecycle.
1. As part of the onboarding process, a creator will list a song and set its price and royalty splits. This information will be locked into a Smart Contract. (A built-in tool will share pricing history, industry pricing statistics, etc.)
2. Each sale and distribution of the song will be recorded with the artist and noted as the full payment (and/or as a royalty).
3. Payments are executed automatically by smart contracts.
4. A MEDIA ASSET royalty gives the creator a percentage of the sale price each time the ASSET is sold on a marketplace. MEDIA ASSET royalty payments are perpetual and made available on the creators dashboard.
5. Crypto wallet integration with [wallet names] is available.
6. Due to the immutable nature of the blockchain and the extensive tracking & tracing of each song, artist, and transaction.

### The MCC-1 Token Standard for Carbon Credits

The MCC-1 Token is the carbon credit standard providing the world access to transparent, verifiable, and environmentally robust premium quality carbon credits leading the Journey to Zero. It entails a fully digital process where carbon offsets are verified and issued through the MCC-1 Token. MCC-1 provides standardization across the asset monetization global marketplace.

The carbon credit tracking, verification, and metering is routinely audited with full transparency in a patent-pending secure online format. All processes and data are secured by the prime quality carbon credit standard-MCC-1. It may be insured by A-rated insurances. Artificial intelligence is added as part of the supply chain strategy and will evolve based on our assets, sensors, and customers.

Carbon sellers first complete a carbon emission reduction agreement. Next, the carbon offsets are validated. This Agreement, between the buyer and seller of carbon credits, is a vital document for developers of carbon offsets to be added onto the Marketplace. It identifies responsibilities, rights, and obligations to manage project risks.

### Carbon Offset Project Categories

This MMC-1 standard embodies the economy and process of assessing, evaluating, and ensuring true carbon credits from any genesis including but not limited to:
A: Forestry
B: Carbon Reducing Technology
C: Fossil Fuels
D: Sustainable Innovations

### Baseline Requirements for a Carbon Credit Standard

A carbon credit is a permit or certificate that allows the holder to emit carbon dioxide (CO2) or other greenhouse gases (GHG) into the atmosphere. Before a carbon reduction becomes a carbon offset and gets minted into an MCC-1 Token carbon credit, it must meet a set of criteria based on methodologies outlined as part of the MCC-1 carbon standard. There is a validation and verification process required to validate a Carbon Offset.

One MCC-1 Token is equivalent to one carbon credit with a value of one ton of CO2e emission reduction, or it's equivalent. A pool representing a batch of 100 credits can be fractionalized into 100 MCC-1 Tokens.

The validation process of each of these carbon offset projects follows a specific, proprietary protocol. There are differences between the protocols developed by the different project types. We are developing a validation process specific to the MCC-1 Token that will become the leading standard. At the most summarized level, a grouping of MCC-1 Tokens must be associated with a carbon offset project and validated and certified as a carbon credit before placed on the Network Platform. This process must validate and document the following elements of a carbon offset project:
Carbon Offset Methodology—A carbon offset owner will select a summarized project type from the Network Project Cards and a more detailed carbon offset methodology providing the details of how carbon offsets are acquired. An example is the selection of an Improvement Forest Management project type through the extended rotation age of logging as the methodology.
Project Specifications—ensuring a valid method of which to measure emissions. A standard that contains the eligibility rules, jurisdictional & ownership rights, project boundaries, project description and objectives, and GHG emission reduction quantification procedures for a specific project type.
Monitoring and Reporting Procedures—required to confirm and continue validation of the carbon credit through the carbon offset lifecycle.
   The project must measure greenhouse gas emission reductions or removals during the project's crediting period. Identification of the specific measurement & monitoring options, data and parameters that will be monitored during the program crediting period. The Network platform reserves the right to monitor key requirements as part of their Tracking & Tracing functionality.
Carbon Offset Location Coverage—The location link assists corporate clients looking to support specific countries and to understand country requirements and carbon reduction goals.
Publication. All project paperwork will be published for auditing, certification, and monitoring requirements.

Each registered project is automatically assigned to a carbon credit expert/validator (depending on multiple variables including project type, location, availability, etc.), responsible for working with our third-party partner network ensuring that the necessary eligibility requirements are met. To ensure best practice measurements and industry acceptance, the MCC-1 Token validation process works with third-party validation and multi-signature verification as part of the Network Platform carbon credit Blockchain Smart Contract process. After the confirmation of the carbon offsets, they will be turned into carbon credits for purchase on the Marketplace.

### Forestry

The objective of the Forestry MCC-1 Token validation process is to combine quality and integrity of the carbon credit certification process with speed and flexibility for the country operators. Specific Forestry project eligibility requirements include:
Forest Carbon Offset Projects. Following, are example project types to be selected for the Carbon Offset Project setup. Below these project types, are specific methodologies resulting in carbon offsets.
a) Afforestation, Reforestation and Revegetation (ARR).
b) Improved Forest Management (IFM).
c) Reduced Emissions from Deforestation and Degradation (REDD+ or REDD).
Additionality estimates are provided as part of the documented methodology.
The Country Operator will be able to select the offset project type card and methodology template from the Network platform.
Carbon Offset Location Coverage—GPS coordinates, latitude and longitude location link identified on Network Platform. Forest projects require acreage specifications and boundary GPS coordinates. This is required to better understand potential country and local requirements for a project and for selection purposes from carbon credit buyers.
Measurements—emission reduction activities must be verifiable and measurable and use an accepted international methodology standard depending on the project type. Activities cannot be accepted based solely on forecasts.
Monitoring and Risk Management—In addition to validating a routine monitoring plan, the platform provides tracking & tracing of the asset throughout the lifecycle including, as appropriate, satellite monitoring of the land and its uses based on the plan.
Permanence—permanence refers to the longevity of removal enhancements and the risk of reversal (i.e., the risk that the emission reduction benefit will not be permanent). The Permanence minimum is 20 years.

Specific Carbon Reduction Technology project eligibility requirements include:
Extensive testing results confirming a significant reduction of CO2 and/or GHG against the current baseline and across multiple testing methodologies, test stage cycles, and competitive technologies. Multiple test results must show consistently improved performance.
Implementation of Global co-operation and international knowledge transfer, as well as tracking progress, such as in the ETP Clean Energy Technology Guide and the IEA Clean Energy Demonstration Projects Database will be vital to accelerate innovation.
Commercialization Plan—Development of a committed commercialization plan and requirements including technical, equity, and sustainability.

### Fossil Fuel

Specific projects related to the oil and gas industries and fossil fuel reduction, include the following additional requirements:
Implementation of Cleaner Fuels & Natural Gas. Develop and provide expertise in exploring, developing, and producing hydrocarbon resources used to supply natural gas. Demonstrate pioneering efforts in areas designed toward cleaner energy. Invest efforts into areas of carbon capture, utilization, and storage.
Detection Technology. Collaborate with industry partners and academia to develop, test, and deploy cutting-edge technologies that can quickly detect methane emissions for potential application across the industry. Drive the use of satellites, which are providing a major boost to overall efforts to increase transparency on emissions sources, especially for very large leaks. On the ground, implement continuous monitoring of methane emissions through next-generation mobile and fixed position sensors.
Implementation of Global Co-Operation and International Knowledge Transfer. Set targets to reduce methane emissions from operated oil and gas assets to near zero methane emissions by 2050. Set a pathway target of energy-related methane emissions to fall by 75% by 2030.
The launch of the Global Methane Pledge needs to be a watershed moment for accelerated action on methane.

### Integrated Security & Enhanced Recognition

The onboarding function both for the sellers and buyers of carbon credits is a unique feature of the MCC-1 Token. As described above, automation in the Smart Contract allows for the certification of carbon offsets into carbon credits. A card-based user interface provides a starting point for a carbon offset owner to select a Project Category and Project Type to initiate a project template.
A facial recognition interface will assist application users to easily get access to the program features.
A Know-Your-Customer (KYC) processing feature is integrated into the application for users to easily identify themselves and gain access to the program features.
Assisted access to an account is controlled by a wallet with MATIC, the native token required to pay for gas on the Polygon blockchain network.

### Tracking and Tracing

Unique, comprehensive tracking is provided through the lifecycle of the carbon credits and provided via a personalized dashboard.

Carbon offset sourcing including location, date, and certification with audit results are integrated per carbon credit.

Monitoring is part of the MCC-1 token solution and satellite monitoring is especially important for forest project categories. Blockchain oracles, decentralized data input to smart contracts, will ensure the agreed upon triggers for payouts and the execution of other contract rules.

Tracking is provided demonstrating permanence (the amount of time that carbon will remain sequestered rather than being released back into the atmosphere through natural processes or human activities which is defined as a minimum of 20 years for the MCC-1 Token), additionality (reductions achieved by a project are ‘additional’ to what would have happened if the project had not been carried out (e.g. continued as business-as-usual), and the mandated retirement of carbon credits.

### Artificial Intelligence

The use of Artificial Intelligence (AI) & machine-learning technology plays a significant role on the platform:
As a key component of the ongoing monitoring and tracking & tracing of the asset and activities on the ground, through the use of blockchain oracles, to ensure the validation of the carbon credit through the lifecycle.
Across data pools for smart contract execution, advanced risk mitigation, and to assist with batched transactions.
To profile users across social platforms and identify demand generation for marketing & targeted opportunities.

While the foregoing disclosure shows illustrative aspects, it should be noted that various changes and modifications could be made herein without departing from the scope of the disclosure as defined by the appended claims. The functions, steps and/or actions of the method claims in accordance with the aspects described herein need not be performed in any particular order. Furthermore, although elements of aspects disclosed herein may be described or claimed in the singular, the plural is contemplated unless limitation to the singular is explicitly stated.

Aspects described in connection with a given description, illustration, representation, or method may be substituted for aspects described in a different description, illustration, representation, or method.

In one or more exemplary embodiments, the functions described may be implemented in hardware, software, firmware, or any combination thereof. If implemented in software as a computer program product, the functions may be stored on or transmitted over as one or more instructions or code on a computer-readable medium. Computer-readable media includes both non-transitory computer-readable storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The terms “central processing unit”, “processor”, “processor circuit”, and “processing circuit”, and variations thereof, as used herein, are used interchangeably and include, but are not limited to, a general purpose processor, a digital signal processor (DSP), an application-specific integrated circuit (ASIC), a field programmable gate array (FPGA) or other programmable logic component, discrete gate or transistor logic, discrete hardware components, or any combination thereof designed to perform the functions described herein. A general purpose processor may include a microprocessor, as well as any conventional processor, controller, microcontroller, or state machine. The processor may also be implemented as a combination of computing components, such as a combination of a DSP and a microprocessor, a number of microprocessors, one or more microprocessors in conjunction with a DSP core, an ASIC and a microprocessor, or any other number of varying configurations. These examples of the processors are for illustration and other suitable configurations within the scope of the disclosure are also contemplated. Furthermore, the processor may be implemented as one or more processors, one or more controllers, and/or other structure configured to execute executable programming. The terms “determine,” “calculate,” and “compute,” and variations thereof, as used herein, are used interchangeably and include any type of methodology, process, mathematical operation or technique.

The previous description of the disclosed embodiments is provided to enable any person skilled in the art to make or use the aspects described herein. Various modifications to these embodiments will be readily apparent to those skilled in the art, and the generic principles defined herein may be applied to other embodiments without departing from the spirit or scope of the invention. Thus, the disclosure is not intended to be limited to the embodiments shown herein but is to be accorded the widest scope consistent with the principles and novel aspects disclosed herein.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A computer system configured to communicate with a distributed blockchain computer system that includes a plurality of computing devices, each computing device of the plurality of computing devices configured to store a copy, or a portion thereof, of a blockchain of a digital blockchain exchange operated by the distributed blockchain computer system, the computer system comprising:
at least one transceiver configured to communicate with one or more of the plurality of computing devices of the distributed blockchain computer system;
at least one processor;
at least one computer readable memory configured to communicate with the processor, the computer readable memory having a non-transitory computer-readable storage medium configured to store instructions, that when executed by the at least one processor, configure the computer system to:
identify, by the computer system, one or more carbon assets of interest;
select, by the computer system, at least one carbon asset from the one or more carbon assets for onboarding onto a storage device;
validate, by the computer system, the at least one carbon asset;
tokenization, by the computer system, of the at least one carbon asset into one or more carbon credit digital tokens; and
monitoring, by the computer system, of the at least one carbon asset using blockchain oracles to ensure the validation of the carbon credit through its lifecycle.

2. The computer system of claim 1, wherein proceeds from a sale of the one or more carbon credit digital tokens are invested into at least one carbon asset of interest.
